(19) United States
(12) Patent Application Publication
(10) Pub. No.: US 2015/0036862 A1
(43) Pub. Date: Feb. 5, 2015

(54) SOUNDER MODULE AND METHOD FOR ASSEMBLING THE SAME

(71) Applicant: GOERTEK INC., WeiFang (CN)

(72) Inventors: Gang Chen, WeiFang (CN); Minghui Shao, WeiFang (CN); Chao Xu, WeiFang (CN); Jiang Xu, WeiFang (CN); Qing Miao, WeiFang (CN); Zongjun Mou, WeiFang (CN)

(21) Appl. No.: 14/380,702

(22) PCT Filed: Oct. 12, 2012
(86) PCT No.: PCT/CN2012/082842

§ 371 Date: Aug. 22, 2014

(30) Foreign Application Priority Data
Feb. 22, 2012 (CN) 201210040837.X

(51) Int. Cl. H04R 9/06; H04R 1/02; H04R 31/00

(52) U.S. Cl. CPC H04R 9/06; H04R 31/006; H04R 1/02; H04R 2209/024; H04R 2400/11; H04R 2201/029
USPC 381/386; 29/594

(57) ABSTRACT

A sounder module, comprising a sounder unit and a casing housing the sounder unit; the sounder unit comprises a magnetic circuit system; the magnetic circuit system comprises a concentrating flux, plate, a magnet and a magnet yoke (33) sequentially assembled; moreover, the casing of the sounder module forms a frame for fixing the magnetic circuit system of the sounder; and the magnetic circuit system and the casing are injection molded to form an integrated structure Also provided is a method for assembling the casing and the magnetic circuit system: a) firstly, sequentially assembling the concentrating flux plate, the magnet and the magnet yoke (33); b) placing the assembled concentrating flux plate, the magnet and the magnet yoke in an injection molder forming the casing; and c) adding molding material, and integrating the magnetic circuit system with the casing.

### TECHNICAL FIELD

The present invention relates to the technical field of electro-acoustic conversion, specifically, to a sounder module and the method for assembling the same.

### BACKGROUND ART

With the rapid development of the consumer electronics market, a large numbers of miniature electro-acoustic components such as sounders are widely used. In practical application, the sounder unit is arranged in the module housed in a casing so as to match the acoustic performance of the sounder.

However, in this type of sounder module, the rated size of the sounder is in constraints due to requirements for the size and structure of the sounder body and the space design of the sounding chamber, and the design of the structure of the product also becomes more complicated. Moreover, taking the assembly process of the sounder and the casing into consideration, the design of the product is complicated for adding an additional assembly process which has adverse effects on the cost efficiency.

Therefore, it is necessary to improve the structure of the prior sounder module and the assembly process thereof to overcome the above drawbacks.

### SUMMARY OF THE INVENTION

The technical problem sought to be solved by the present invention is to provide a sounder module capable of increasing the size of the sounder unit on condition that the size of the sounder module is defined, and to provide a method for assembling the sounder module by which the assembly process and processing steps are simplified and the production cost is lowered.

In order to achieve the above objectives, the present invention provides the following technical solution:

A sounder module comprises a sounder unit and a casing housing the sounder unit; the sounder unit comprises a magnetic circuit system; the magnetic circuit system comprises a concentrating flux plate, a magnet and a magnet yoke sequentially assembled; moreover, the casing of the sounder module forms a frame for fixing the magnetic circuit system; and the magnetic circuit system and the casing are injection molded to form an integrated structure.

As an improvement, the magnetic circuit system is in an elongated form, and an opening portion is provided at a position of the magnetic yoke corresponding to the long axis side of the magnetic circuit system, the concentrating flux plate and the magnet are installed correspondingly at the opening portion; and the casing and the concentrating flux plate, and the magnet and the magnetic yoke are injection molded integrally.

As an improvement, the magnetic circuit system is wrapped by the same injection materials as in the injection molding for forming the casing.

As an improvement, the casing comprises a first casing part and a second casing part.

As an improvement, the magnetic circuit system has a dual magnetic circuit structure comprising an external concentrating flux plate and an external magnet, and an internal concentrating flux plate and an internal magnet which are sequentially assembled with the magnetic yoke respectively; and the external concentrating flux plate and the external magnet, and the magnetic yoke are injection molded integrally with the casing.

A method for assembling the sounder module is further provided, wherein the casing and the magnetic circuit system are assembled by the following steps:

(a) assembling the concentrating flux plate, the magnet and the magnetic yoke sequentially;

(b) placing the assembled concentrating flux plate, the magnet and the magnet yoke in an injection molder for forming the casing; and

(c) adding molding material, and injection molding integrally the casing for the magnetic circuit system and the sounder module.

As an improvement, the magnetic circuit system has a dual magnetic circuit structure comprising an external concentrating flux plate and an external magnet, and an internal concentrating flux plate and an internal magnet which are sequentially assembled with the magnetic yoke respectively; and the casing and the magnetic circuit system are assembled by the following steps:

(a) firstly, sequentially assembling the external concentrating flux plate, the external magnet and the magnet yoke;

(b) placing the assembled external concentrating flux plate, the external magnet and the magnet yoke in an injection molder for forming the casing;

(c) adding molding material, and injection molding integrally the casing for the magnetic circuit system and the sounder module; and

(d) assembling the internal concentrating flux plate, the internal magnet and the magnetic yoke sequentially.

As an improvement, the casing comprises a first casing part and a second casing part, and the magnetic circuit system is injection molded integrally with the first casing part.

With the above technical scheme, the present invention provides a sounder module, wherein the casing of the sounder module also serves as a frame for fixing the magnetic circuit system of the sounder unit and the magnetic circuit system is injection molded integrally with the casing, which can decrease the internal dimension of the sounder unit, simplify the product design, and facilitate increasing the size of the sounder unit. Meanwhile, with the method for assembling the sounder module provided by the present invention, the magnetic circuit system is pre-assembled and injection molded integrally with the casing, simplifying the assembly process and processing steps, and reducing production cost.

In order to achieve the above and related objectives, one or more aspects of the present invention comprise the features detailed below and specified particularly in the claims. Some exemplary aspects of the present invention are described in details by the description below and the accompanying drawings. However, these aspects only indicate some implementations of various implementations of the present invention. In addition, the present invention is intended to include all these aspects and their equivalents.

### BRIEF DESCRIPTION OF THE DRAWINGS

By referring to the descriptions of the embodiments and the claims in connection with the drawings, and with a full understanding of the present invention, other purposes and results of the present invention will be more clearly and easily understood. In the figures:

FIG. 1 is a schematic exploded view of the sounder module according to the present invention;

FIG. 2 is a cross sectional view of the sounder module according to the present invention;

FIG. 3 is a schematic assembly view of the external magnetic circuit of the sounder module according to the present invention;

FIG. 4 is a schematic view after the magnetic circuit system of the sounder module is molded with the first casing part according to the present invention; and

FIG. 5 is a cross sectional view taken along line A-A of FIG. 4.

Throughout the drawings, similar signs indicate similar or corresponding features or functions.

### DETAILED DESCRIPTION OF THE EMBODIMENTS

Various specific details are set forth in the following description to comprehensively understand one or more embodiments for sake of illustration. However, it is obvious that these embodiments may be implemented without such specific details. In other examples, known structures and devices are showed by block diagrams to facilitate describing one or more embodiments.

The detailed structure of the present invention will be described in connection with the accompanying drawings.

### EMBODIMENTS

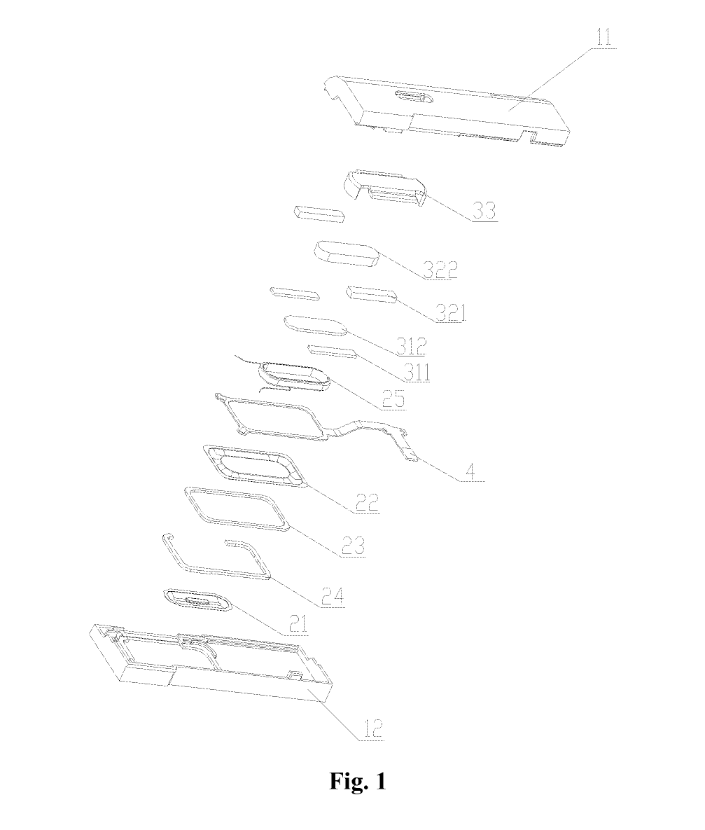

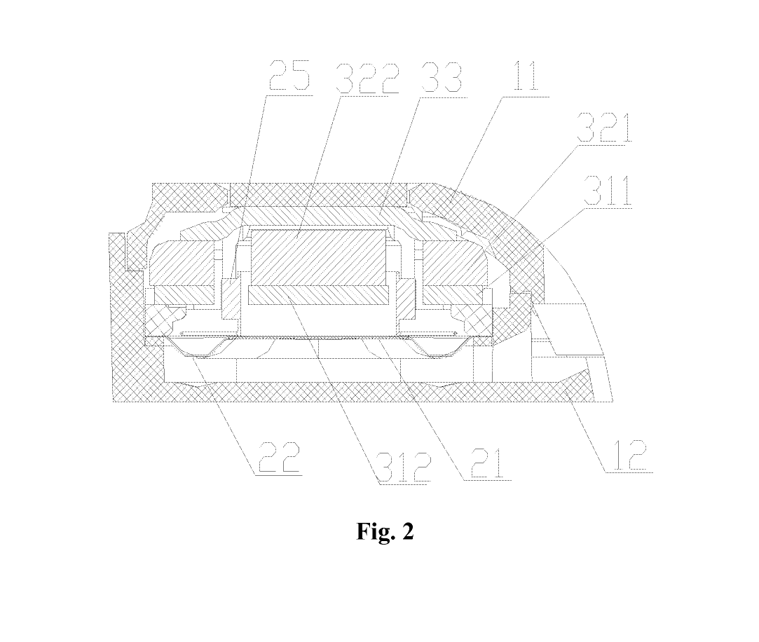

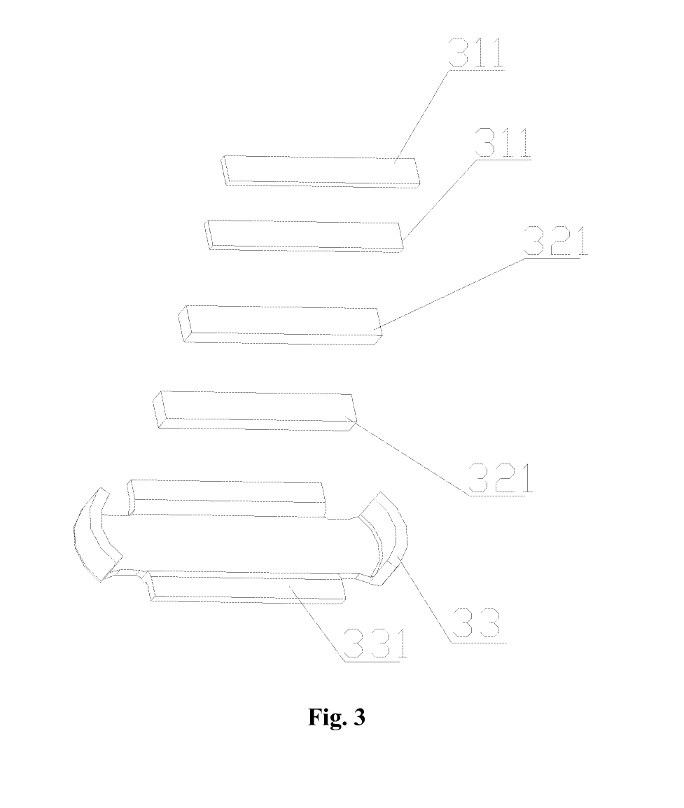

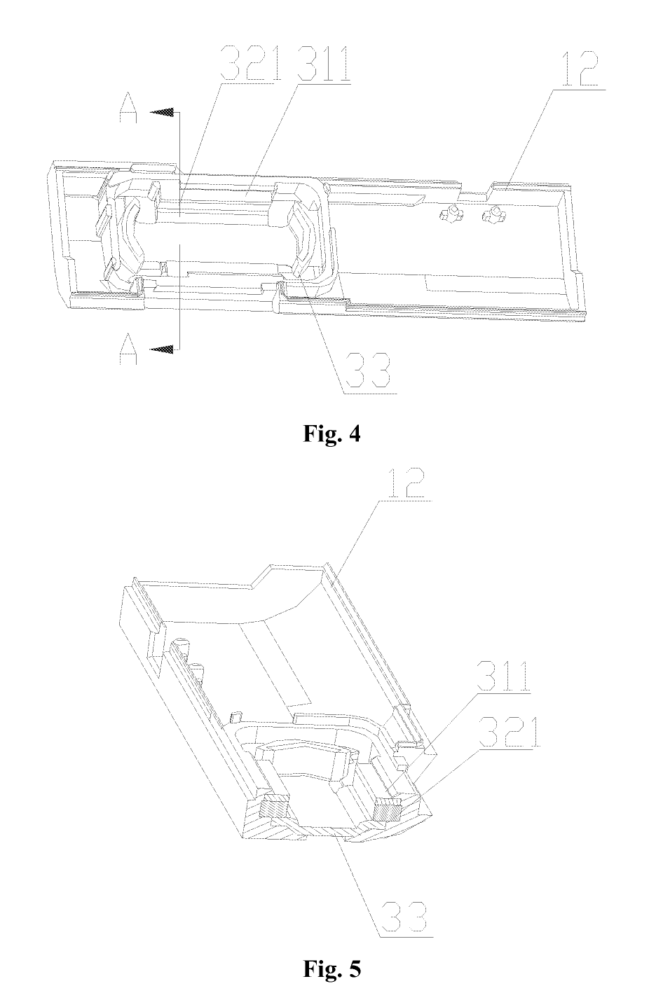

As illustrated in FIG. 1 to FIG. 5, the present invention provides a sounder module comprising a sounder unit and a casing housing the sounder unit, the casing preferably comprises a first casing part 11 and a second casing part 12 cooperating with the first casing part, and the sounder unit comprises a vibration system and a magnetic circuit system.

The vibration system comprises a diaphragm formed by a middle portion 21 and an edge portion 22, a supporting member 23 provided on the edge portion 22, and a resilient member 24 provided between the edge portion 22 and the lower shell 12, wherein preferably the supporting member 23 is a copper ring, and the resilient member 24 is preferably foam. The magnetic circuit system comprises a concentrating flux plate, a magnet and a magnetic yoke which are assembled sequentially. The magnetic circuit system in the present embodiment has a dual magnetic circuit structure, comprising an external concentrating flux plate 311 and an external magnet 321, and an internal concentrating flux plate 312 and an internal magnet 322 which are sequentially assembled with the magnetic yoke 33 respectively.

In the present embodiment, the first casing part 11 forms a frame for fixing the magnetic circuit system of the sounder unit; and the magnetic circuit system and the first casing part 11 are injection molded to form an integrated structure.

With such design in which the first casing part 11 serves as a frame for fixing the magnetic circuit system of the sounder unit and the magnetic circuit system is injection molded integrally with the first casing part 11, it may increase the size of the sounder unit with a defined size of the sounder module while the product design is simplified.

Specifically, preferably the magnetic circuit system is in an elongated form, and an opening portion 331 is provided at a position of the magnetic yoke 33 corresponding to the long axis side of the magnetic circuit system, the external concentrating flux plate 311 and the external magnet 321 are installed correspondingly at the opening portion 331 of the magnetic yoke 33; and the first casing part 11 is injection molded integrally with the external concentrating flux plate 311, the external magnet 321 and the magnetic yoke 33. With such design, the magnetic circuit system may be wrapped by the same injection material as used for forming the first casing part 11, thereby improving the strength of the integral structure of the magnetic circuit system and the first casing part.

In the present embodiment, the casing may be formed by components of other structures or numbers. The sounder unit of a dual magnetic circuit structure disclosed herein is only one preferred embodiment of the present invention, and a magnetic circuit structure of only one magnet, such as an internal or external magnetic circuit design, may be also adopted in the present invention, which does not affect the implementation of the present invention.

The casing of the sounder module and the magnetic circuit system of the sounder unit in the embodiment are assembled by the following steps:

(a) assembling the concentrating flux plate and the magnet and the magnetic yoke 33 sequentially;

(b) placing the assembled concentrating flux plate, the magnet and the magnet yoke in an injection molder for forming the casing; and

(c) adding molding material, and injection molding integrally the magnetic circuit system with the casing of the sounder module.

In this assembly method, the magnetic circuit system is pre-assembled and formed integrally with the casing, which can simplify the assembly process and processing steps, and reduce production cost.

With respect to the sounder unit of the dual magnetic circuit structure in the present embodiment, preferably, the casing is assembled by the following steps:

(a) assembling the external concentrating flux plate 311 and the external magnet 321 and the magnet yoke 33 sequentially;

(b) placing the assembled external concentrating flux plate 311, the external magnet 321 and the magnet yoke 33 in an injection molder for forming the casing;

(c) adding molding material, and forming the magnetic circuit system integrally with the casing of the sounder module; and

(d) assembling the internal concentrating flux plate 312, the internal magnet 322 and the magnetic yoke 33 sequentially.

The sounder unit of dual magnetic circuit structure is assembled by the above assembly method, thereby simplifying the process and achieving better technical effects of the present invention.

Preferably, the casing comprises a first casing part 11 and a second casing part 12, and the magnetic circuit system is injection molded integrally with the first casing part 11. Such design simplifies the process further.

As described above, the sounder module and the method for assembling the same are described by way of example with reference to the accompanying drawings. However, it should be understood by those skilled in the art that the abovementioned embodiments are only specific embodiments of the present invention and should not be construed as limiting the present invention, and various improvements can be made to the sounder module and the method for assembling the same without departing from the spirits of the present invention. Therefore, the scope of protection of the present invention should be defined by the appended claims.

1-8. (canceled)

9. A sounder module, comprising a sounder unit and a casing which houses the sounder unit, wherein the sounder unit comprises a magnetic circuit system; the magnetic circuit system comprises a concentrating flux plate, a magnet and a magnet yoke sequentially assembled, the sounder module is characterized in that:
the casing forms a frame for fixing the magnetic circuit system of the sounder; and
the magnetic circuit system and the casing are injection molded to form an integrated structure.

10. The sounder module according to claim 9, characterized in that:
the magnetic circuit system is in an elongated form, and an opening portion is provided at a position of the magnetic yoke corresponding to the long axis side of the magnetic circuit system, the concentrating flux plate and the magnet are installed correspondingly at the opening portion; and the casing and the concentrating flux plate, the magnet and the magnetic yoke are injection molded integrally.

11. The sounder module according to claim 10, characterized in that:
the magnetic circuit system is wrapped by the same injection materials as in the injection molding of the casing.

12. The sounder module according to claim 9, characterized in that the casing comprises a first casing part and a second casing part.

13. The sounder module according to claim 10, characterized in that the casing comprises a first casing part and a second casing part.

14. The sounder module according to claim 11, characterized in that the casing comprises a first casing part and a second casing part.

15. The sounder module according to claim 9, characterized in that the magnetic circuit system has a dual magnetic circuit structure comprising an external concentrating flux plate and an external magnet, and an internal concentrating flux plate and an internal magnet which are sequentially assembled with the magnetic yoke respectively; and the external concentrating flux plate and the external magnet, and the magnetic yoke are injected integrally with the casing.

16. The sounder module according to claim 10, characterized in that the magnetic circuit system has a dual magnetic circuit structure comprising an external concentrating flux plate and an external magnet, and an internal concentrating flux plate and an internal magnet which are sequentially assembled with the magnetic yoke respectively; and the external concentrating flux plate and the external magnet, and the magnetic yoke are injected integrally with the casing.

17. The sounder module according to claim 11, characterized in that the magnetic circuit system has a dual magnetic circuit structure comprising an external concentrating flux plate and an external magnet, and an internal concentrating flux plate and an internal magnet which are sequentially assembled with the magnetic yoke respectively; and the external concentrating flux plate and the external magnet, and the magnetic yoke are injected integrally with the casing.

18. A method for assembling the sounder module according to claim 9, characterized in that the casing and the magnetic circuit system are assembled by the following steps:
(a) assembling the concentrating flux plate, the magnet with the magnetic yoke sequentially;
(b) placing the assembled concentrating flux plate, the magnet and the magnet yoke in an injection molder, which molder is used for forming the casing; and
(c) adding molding material, and molding integrally the magnetic circuit system with the casing of the sounder module.

19. The method for assembling the sounder module according to claim 18, characterized in that, the magnetic circuit system has a dual magnetic circuit structure comprising an external concentrating flux plate and an external magnet, and an internal concentrating flux plate and an internal magnet which are sequentially assembled with the magnetic yoke respectively; and the casing and the magnetic circuit system are assembled by the following steps:
(a): firstly, sequentially assembling the external concentrating flux plate, the external magnet with the magnet yoke;
(b): placing the assembled external concentrating flux plate, the external magnet and the magnet yoke in an injection molder which is used for forming the casing;
(c): adding molding material, and molding integrally the magnetic circuit system with the casing of the sounder module; and
(d): assembling the internal concentrating flux plate, the internal magnet with the magnetic yoke sequentially.

20. The method for assembling the sounder module according to claim 18, characterized in that, the casing comprises a first casing part and the second casing part, and the magnetic circuit system is injection molded integrally with the first casing part.

21. The method for assembling the sounder module according to claim 19, characterized in that, the casing comprises a first casing part and the second casing part, and the magnetic circuit system is injection molded integrally with the first casing part.
